(19) United States
(12) Patent Application Publication
(10) Pub. No.: US 2010/0187413 A1
(43) Pub. Date: Jul. 29, 2010

(54) High Temperature Photodetectors Utilizing Photon Enhanced Emission

(75) Inventors: Rocco DiFoggio, Houston, TX (US); Anton Nikitin, Houston, TX (US)

Correspondence Address: CANTOR COLBURN LLP- BAKER HUGHES INCORPORATED, 20 Church Street, 22nd Floor, Hartford, CT, 06103, US

(73) Assignee: BAKER HUGHES INCORPORATED, Houston, TX (US)

(21) Appl. No.: 12/685,028

(22) Filed: Jan. 11, 2010

Related U.S. Application Data
(60) Provisional application No. 61/148,224, filed on Jan. 29, 2009.

(51) Int. Cl. G01V 5/00

(52) U.S. Cl. 250/269.1; 977/742; 977/762; 977/902

(57) ABSTRACT

An apparatus for estimating a property of a subterranean material, the apparatus including: a photon induced emission device configured to be disposed in a borehole penetrating the subterranean material and to provide an output related to an induced emission interaction with a received photon that generates an electron that is used for providing the output; wherein the output is used for estimating the property.

### CROSS-REFERENCE TO RELATED APPLICATIONS

This application claims the benefit of U.S. Provisional Application Ser. No. 61/148,224, entitled “High Temperature Photodetectors Utilizing Photon Enhanced Emission”, filed Jan. 29, 2009, under 35 U.S.C. §119(e), and which is incorporated herein by reference in its entirety.

### BACKGROUND OF THE INVENTION

1. Field of the Invention

The invention disclosed herein relates to well logging and, in particular, to photodetectors used in logging tools.

2. Description of the Related Art

Exploration for energy such as hydrocarbons or geothermal sources generally requires drilling a borehole into the earth. The borehole can be used to gain access to depths of the earth for performing measurements related to the exploration for energy.

Well logging is a technique used to perform the measurements from the borehole. In well logging, a logging tool is conveyed through the borehole. The logging tool includes those components used to perform the measurements. In one embodiment, a wireline is used to support the logging tool and to transmit the measurements to the surface of the earth for processing and recording.

Many types of measurements can be performed from within the borehole. Some of these measurements use a photodetector to measure light where the light is associated with a property being measured. For example, the photodetector can be used to measure light emitted from a spectrographic analysis of a material in the borehole where an intensity of the light is related to the composition of the material. As another example, the photodetector can be used to measure radiation. In radiation measuring applications, the radiation interacts with a scintillator, which emits light in relation to the amount of radiation interacting in the scintillator. The emitted light is then detected and measured by the photodetector. Photodetectors, in general, generate an output signal in relation to an amount of light detected.

Temperatures experienced by the photodetector in a borehole environment can be very high. The high temperatures can cause problems with conventional photodetectors detecting light. For example, a conventional photodetector fabricated from a semiconductor for detecting visible light and near infrared light has a much reduced response at high temperature and ten million times worse shunt resistance. In another example, an embodiment of a conventional photodetector may be a photomultiplier tube. The conventional photomutltiplier tube may be used to measure violet and blue colored light emitted by a scintillator crystal in some gamma ray detecting tools. However, the conventional photomultiplier tube can be permanently degraded by the high temperature of the borehole environment. The degradation is caused by evaporation of photocathode materials. Because of the degradation, the conventional photomultiplier tube typically has a lifetime of 1,000 hours at 150° C. and 100-200 hours at 175° C.

Therefore, what are needed are techniques for detecting light in a high temperature downhole environment. Preferably, the techniques provide a response and lifetime that do not degrade with increasing temperature.

### BRIEF SUMMARY OF THE INVENTION

Disclosed is an apparatus for estimating a property of a subterranean material, the apparatus including: a photon induced emission device configured to be disposed in a borehole penetrating the subterranean material and to provide an output related to an induced emission interaction with a received photon that generates an electron that is used for providing the output; wherein the output is used for estimating the property.

Also disclosed is a method for estimating a property of a subterranean material penetrated by a borehole, the method including: disposing a photon induced emission device in the borehole, the photon induced emission device being configured to provide an output related to an induced emission interaction with a received photon that generates an electron that is used for providing the output wherein the output is used for estimating the property; receiving a photon to produce the induced emission interaction that generates the electron; and using the electron to provide the output to estimate the property.

Further disclosed is a computer readable medium having computer executable instructions for estimating a property of a subterranean material penetrated by a borehole by implementing a method including: generating output from a photon induced emission device configured to be disposed in the borehole and to provide an output related to an induced emission interaction with a received photon that generates an electron that is used for providing the output wherein the output is used for estimating the property; and using the output to estimate the property.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 illustrates an exemplary embodiment of a logging tool disposed in a borehole penetrating the earth;

FIG. 2 depicts aspects of a photodetector using photon enhanced thermionic emission;

FIG. 3 depicts aspects of a photodetector using photon enhanced field emission;

FIG. 4 depicts aspects of measuring light that is transmitted through a fluid under investigation using a photon enhanced thermionic emission photodetector;

FIG. 5 depicts aspects of measuring light that is transmitted through the fluid under investigation using a photon enhanced field emission photodetector;

FIG. 6 depicts aspects of receiving light from a large aperture spectrometer;

FIG. 7 depicts aspects of receiving light from a small aperture spectrometer;

FIG. 8 depicts aspects of measuring radiation with the photon enhanced emission photodetector;

FIG. 9 presents one example of a method for estimating a property of an earth formation penetrated by the borehole.

FIGS. 10A and 10B, collectively referred to as FIG. 10, depict aspects of a photodetector having internal signal amplification with a diode configuration; and

FIG. 11 depicts aspects of a photodetector having internal signal amplification with a triode configuration.

### DETAILED DESCRIPTION OF THE INVENTION

Disclosed are embodiments of techniques for detecting light at high temperatures experienced in a downhole environment. In general, the detection of light is used for estimating a property of an earth formation, a fluid from an earth formation, or a drilling fluid downhole. The techniques provide a response to detected light and a detector lifetime that do not generally degrade at the high temperatures. The term “detecting” as in “detecting light” inherently includes measuring a magnitude, an intensity or strength of the light. The techniques, which include apparatus and method, call for detecting photons using “photon enhanced emission” of electrons from a conducting surface. The emitted electrons are measured and related to an amount of photons causing the photon enhanced emission. Photon enhanced emission may also be referred to as “photon induced emission.” The potential for photon enhanced emission is created by at least one of two conditions.

The first condition is heating the conducting surface, such as vacuum tube filament cathode, to a temperature where a significant number of electrons are excited to levels within one photon's energy of the free electron energy. Thus, a photon colliding with the surface will impart enough energy for an electron to escape the surface and become a free electron. The free electron(s) then creates an electric current, which is a measure of the amount of photons colliding with the surface. This first condition may be referred to as “photon enhanced thermionic emission” or “photon assisted thermionic emission.”

The second condition for creating the potential for photon enhanced emission is created by placing the conductive surface under an extreme electric field. The strength of the electric field is such as to narrow the work function potential barrier to electron escape sufficiently to allow an electron to escape the surface after collision with a photon. As with the first condition, the free electron(s) then creates an electric current, which is a measure of the amount of photons colliding with the surface. The second condition may be referred to as “photon enhanced field emission,” “photon assisted field emission,” or “photon induced emission.” In both cases, in the absence of light, some electrons will be emitted by thermionic emission alone (described by the Richardson-Dushman equation) or by field emission alone (described by the Fowler-Nordheim equation), and these electrons constitute a steady “dark current” that can be measured and subtracted from the total current to obtain the net current due to illumination.

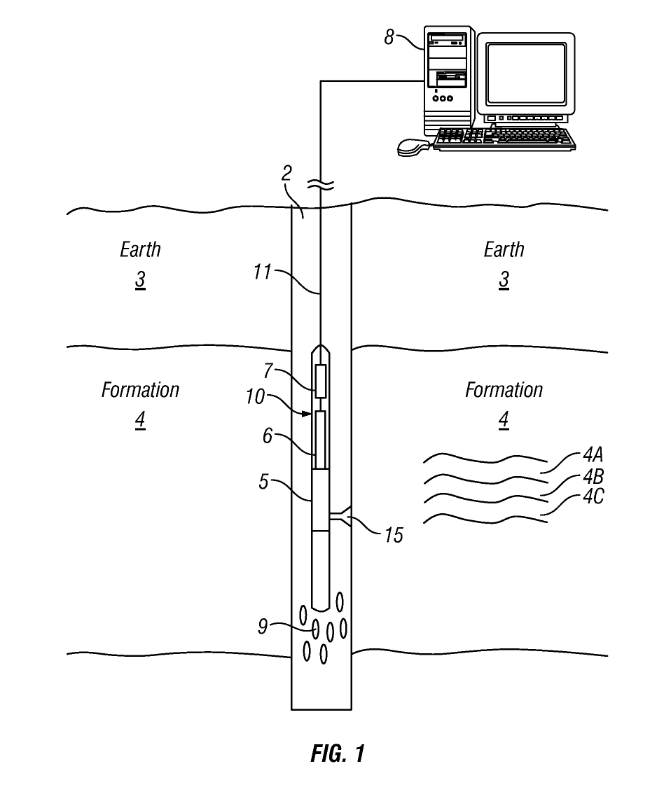

Reference may now be had to FIG. 1. FIG. 1 illustrates an exemplary embodiment of a logging tool 10 disposed in a borehole 2 penetrating the earth 3. The earth 3 includes an earth formation 4, which represents features of interest that may be measured by the logging tool 10. The formation 4 in FIG. 1 includes various layers 4A-4C. The logging tool 10 is supported by a wireline 11 for logging operations referred to as “wireline logging.” The logging tool 10 includes measurement apparatus 5 that includes components configured for performing a measurement. The measurement can be of the formation 4, a borehole fluid 9 disposed in the borehole 2 and surrounding the logging instrument 10, or a formation fluid pumped from the borehole wall. The formation fluid is extracted from the formation 4 with a fluid extraction device 15. The borehole fluid 9 can include fluids such as formation fluids and drilling mud. At least one portion of the measurement includes detecting light. Thus, a photon induced emission device 6 configured as a photodetector (i.e., a photodetector 6) is optically coupled to the measurement apparatus 5 for detecting light emitted by the measurement apparatus 5. The photodetector 6 measures the intensity of the light and a processing system and/or electronic unit relates the intensity to a value of the property being measured.

Referring to FIG. 1, the logging tool 10 includes an electronic unit 7 coupled to the photodetector 6. The electronic unit 7 can be used to operate the measurement apparatus 5 and/or photodetector 6 to receive and process data related to measurements performed by the measurement apparatus 5 and/or photodetector 6. In one embodiment, the electronic unit 7 stores the data for later retrieval when the logging tool 10 is removed from the borehole 2. In another embodiment, the data is transmitted to the surface of the earth 3 to a processing system 8. The processing system 8 can record and process the data either independently or in conjunction with the electronic unit 7.

While the embodiment of FIG. 1 shows the logging tool 10 conveyed through the borehole 2 using the wireline 11, in other embodiments, the logging tool 10 can be conveyed by slickline or coiled tubing or by a drill string for logging-while-drilling (LWD) applications. In the LWD applications, the logging tool 10 may be disposed in a collar attached to the drill string.

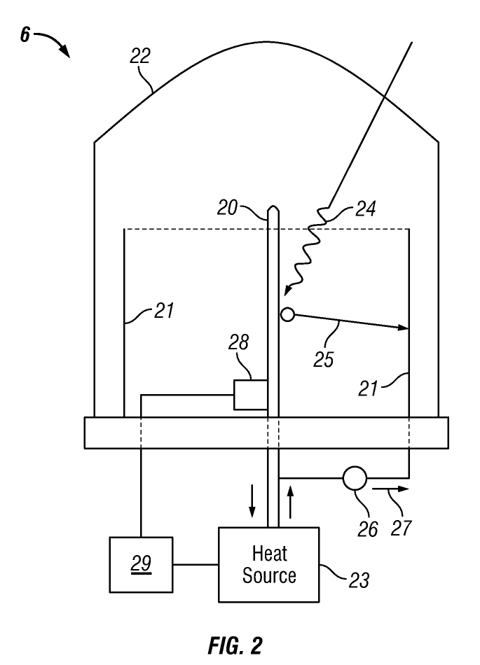

FIG. 2 depicts aspects of the photodetector 6 using photon enhanced thermionic emission. In the embodiment of FIG. 2, a cathode 20 having a conducting surface and an anode 21 (alternatively called “plate”) are disposed in an enclosure 22 containing a vacuum. The anode 21 in FIG. 2 is cylindrically shaped with one end open to allow entry of photons from the measurement apparatus 5. A heat source 23 provides energy to heat the cathode 20 to a temperature sufficient for electrons at the cathode 20 to be within a photon's energy of the free electron energy. In one embodiment, the heat source 23 can be an electrical power source that provides energy to the cathode 20 by conducting electrical current through the cathode 20. Also depicted in FIG. 2 is a current sensor 26 that measures current 27 generated by the electrons 25 being collected by the anode 21.

Referring to FIG. 2, a photon 24 collides with an electron 25 at the cathode 20. The photon 24 imparts enough energy to the electron 25 from the collision to free the electron 25 from the cathode 20. That is, after the collision, the energy of the electron 25 meets or exceeds the free electron energy. The free electron 25 is then collected by the anode 21. To insure that the free electron 25 is collected by the anode 21, the anode 21 is kept at a higher voltage potential (positive with respect to the cathode 20) than the cathode 20.

Various techniques can be used to insure that electrons 25 at the conducting surface 20 are at an energy that is within one photon's energy of the free electron energy. Referring to FIG. 2, a sensor 28 is used to sense the energy of the electrons 25. The sensor 28, which may be a temperature sensor, is coupled to a controller 29. The controller 29, in turn, is coupled to the heat source 23. Thus, the sensor 28, the controller 29, and the heat source 23 form a feedback control loop to insure that the electrons 25 are at the proper energy level for photon enhanced thermionic emission.

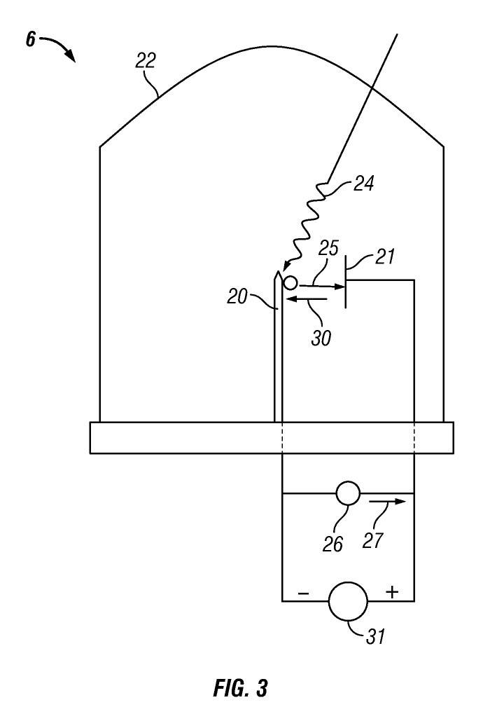

FIG. 3 depicts aspects of the photodetector 6 using photon enhanced field emission. In the embodiment of FIG. 3, the cathode 20 and the anode 21 are also disposed in the enclosure 22 containing a vacuum. Further, in the embodiment of FIG. 3, the cathode 20 is not heated but subjected to an intense electric field 30. The electric field 30 is created by applying a voltage with a voltage source 31 between the cathode 20 and the anode 21. The voltage is high enough to narrow the work function potential barrier to electron escape to a level that allows the electron 25 to escape the cathode 20 after collision with the photon 24, but low enough to prevent emission of the electron 25 without colliding with the photon 24. In some instances, after the collision, the electron 25 has enough energy to significantly increase the probability of the electron 25 tunneling through a potential barrier (i.e., work function) to become free. In addition to the voltage being high enough to allow photon enhanced field emission, the voltage is also low enough to prevent arcing between the cathode 20 and the anode 21. The photon 24 is generally emitted from the tip of the cathode 20 where the electric field 30 is most intense because the electric field strength at the surface of an arbitrarily-shaped conductor is inversely related to the local radius of curvature and electron tunneling probability increases with the local electric field strength. The electric field 30 is generally greatest at a tip of the cathode 20 having a high aspect ratio (i.e., ratio of the length to width or diameter of the cathode 20 where the longitudinal axis of the cathode 20 is aligned with the electric field 30) and high curvature of the tip. The cathode 20 used for photon enhanced field emission may be referred to as an emitter 20. In one embodiment, there may be a plurality of emitters 20 in order to increase the efficiency of photon induced field emission interactions (i.e., to increase the efficiency of detecting incoming photons 24).

Because it is desirable to achieve an increased probability of photon enhanced emission, the plurality of emitters 20 may be used to increase the total surface area (number of emitters 20 multiplied by the tip area per emitter 20), which is available for photon assisted tunneling. In one embodiment, nanowires, nanotubes or their bundles may be selected for the emitters 20. In general, the diameter of a nanowire or nanotube is on the order of a few nanometers and can have an aspect ratio as high as twenty-eight million. Different materials such as metals including but not limited to gold, semiconductors including but not limited to germanium and silicon, or semimetals including but not limited to carbon, boron carbide and boron nitride may be selected as a material for the nanowires and nanotubes because of their conducting properties.

In one embodiment, carbon nanotube film may be deposited on a cathode structure either from a carbon nanotube suspension by a “drop-dry” technique or by using carbon nanotube film grown on a substrate and then transferred to the cathode structure. In addition, carbon nanotube film may be directly grown on the cathode structure.

Various techniques can be used to insure that the strength of the electric field 30 is sufficient to allow photon enhanced field emission from the tip of the cathode 20 shown in FIG. 3. For example, simply measuring the field emitted current in the absence of illumination (i.e., the dark current) can serve as a measure of electric field 30 at the field emitter tip when the tip's radius and work function are known. Then, the electric field 30 can be controlled by varying the voltage of voltage source 31 and forming a feedback control loop. The Fowler-Nordheim equation relates the field emission current to voltage for a given tip radius, work function, etc. so one can extrapolate how the current will change with voltage in order to stay below the voltage that will cause an arc and destroy the tip.

The embodiments of the photodetector 6 depicted in FIGS. 2 and 3 show one cathode 20 and one anode 21 in the enclosure 22. Other embodiments of the photodetector 6 can have a plurality of cathodes 20 and/or a plurality of anodes 21 in the enclosure 22. In one embodiment, the photodetector 6 can have a plurality of cathodes 20 surrounded by a cylindrically shaped anode 21 (as depicted in FIG. 2) where an open end of the anode 21 faces a source of photons to be detected.

The photon induced emission device 6 can be built in various ways. For example, the photon induced emission device 6 can be built on a “macro” scale using a glass tube (i.e., vacuum tube) as the enclosure 22. In one embodiment, the glass tube can be coupled to a base that includes connections for a sensor, a power supply, a voltage supply, a current sensor or another component. As another example, the photon induced emission device 6 can be built on a “micro” scale as a micro-electro-mechanical-system (MEMS). The MEMS photon induced emission device 6 is generally fabricated from a substrate made from a semiconductor material such as silicon. Fabrication techniques such as photolithography and micro-machining used for fabricating semiconductor electronic chips can be used to build the MEMS photon induced emission device 6.

The photodetector 6 has advantages over the prior art photodetectors. One advantage is that the photodetector 6 can operate at high temperatures of up to 300° C. or more without a degraded response. Another advantage is that the photodetector 6 has an extended life in the borehole environment. In the embodiment of a MEMS and operating as a photon enhanced thermionic emitter, the photodetector 6 was shown to operate at between 600° C. and 1000° C. and extrapolated to last for twenty years. The filament or cathode 20 in this embodiment has a coating with a low work function of 1.8 eV. Coatings of components such as the cathode 20 and the anode 21 are selected to not evaporate and to survive at the high temperatures encountered in the borehole 2. In addition, the coatings are selected to have the proper work function to support the photon enhanced thermionic emission or the photon enhanced field emission.

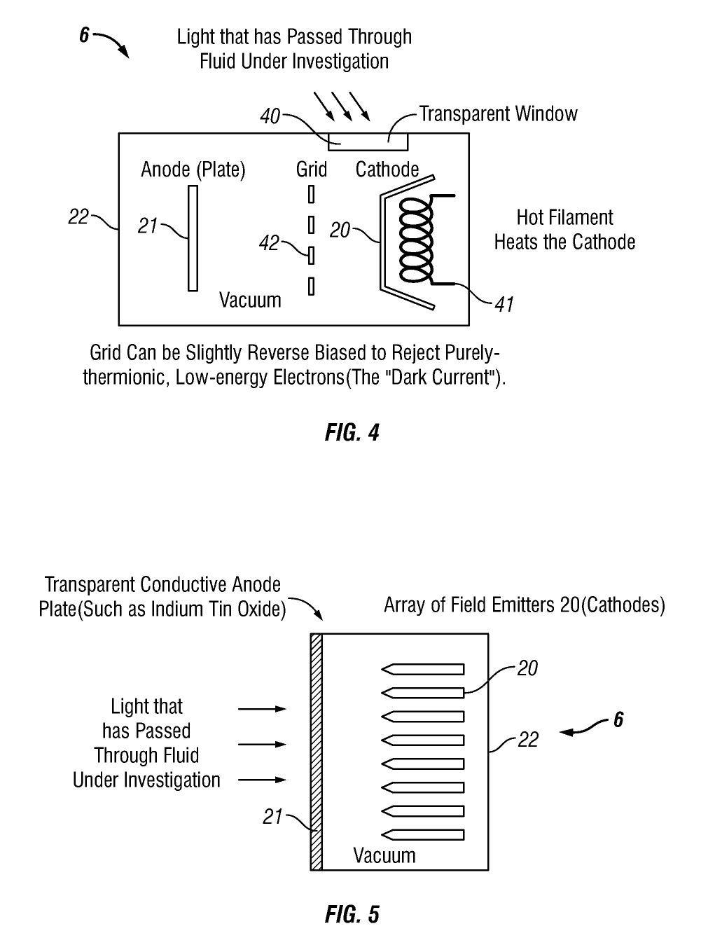

FIGS. 4-8 present some exemplary embodiments of applications of the logging tool 10 using the photodetector 6. FIG. 4 depicts aspects of measuring light that is transmitted through a fluid under investigation. The amount of light transmitted can be related to a property of the fluid. The fluid can be the borehole fluid 9 or a fluid extracted from the formation 4. The light enters the photodetector 6 through a transparent window 40. A filament 41 heats the cathode 20 to provide photon enhanced thermionic emission. A grid 42 is disposed between the cathode 20 and the anode 21. The grid 42 can be slightly reversed biased to reject purely thermionic, low-energy electrons (the dark current).

As with FIG. 4, the embodiment of FIG. 5 also measures the light transmitted through the fluid. In the embodiment of FIG. 5, the photodetector 6 is configured for photon enhanced field emission and has an array of field emitters 20 (i.e., cathodes 20). The transmitted light enters the photodetector 6 through the anode 21, which is a transparent conductive anode plate made from a material such as indium-tin-oxide (ITO) or other transparent conductors like graphene.

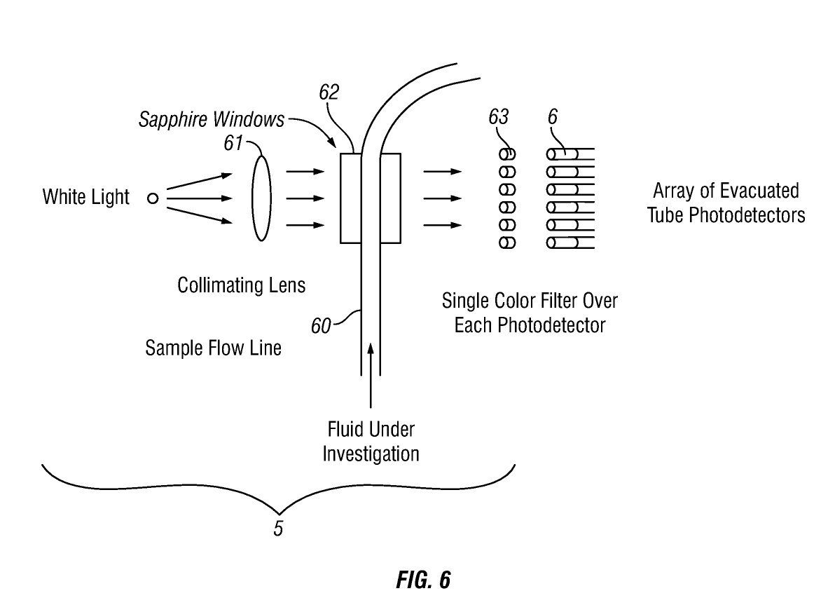

FIG. 6 depicts aspects of a large aperture spectrometer used as the measurement apparatus 5. In the embodiment of FIG. 6, the fluid enters a sample flow line 60. White light is collimated by a collimating lens 61. The collimated light enters and exits the sample flow line 60 via a sapphire window 62. The exiting light then enters a plurality of single color filters 63. Each color filter 63 is optically disposed in a light path leading to one photodetector 6. By using the single color filters 63, each of the photodetectors 6 can measure an intensity of light of a certain wavelength or range of wavelengths to measure a property of the fluid.

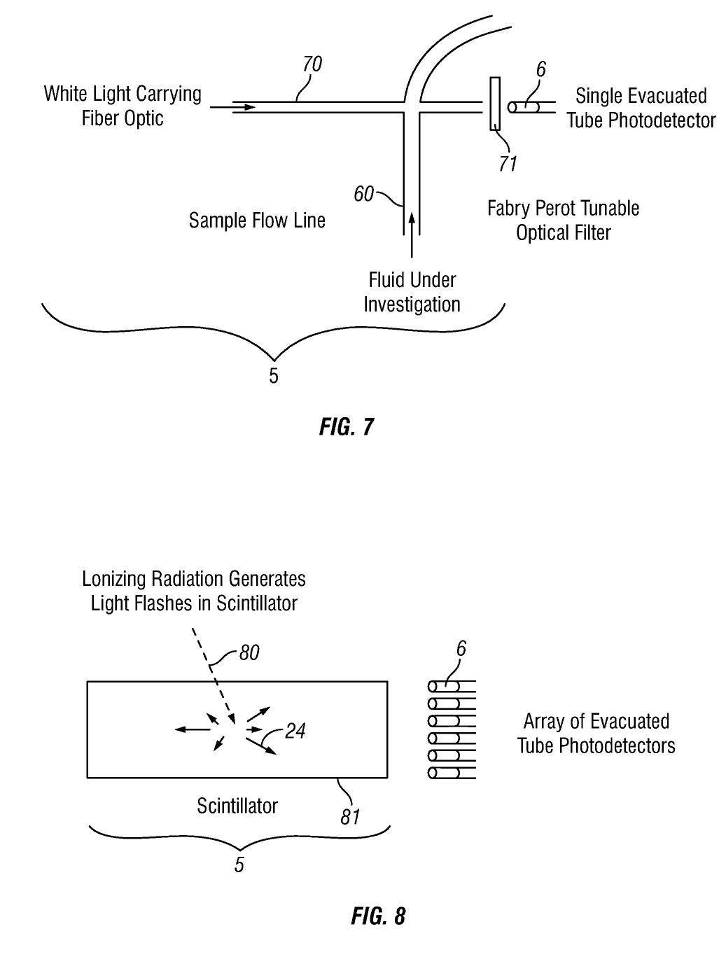

FIG. 7 depicts aspects of a small aperture spectrometer used as the measurement apparatus 5. In the embodiment of FIG. 7, white light is transmitted to the sample flow line 60 via an optical fiber 70. Light exiting the sample line 60 is transmitted via the optical fiber 70 to a Fabry Perot tunable optical filter 71. The Fabry Perot tunable optical filter 71 is disposed in a light path leading to a single evacuated tube photodetector 6. The filter 71 allows selecting a certain wavelength or range of wavelengths of the exiting light to pass through the filter 71. Thus, by measuring an intensity of different wavelengths of light transmitted through the fluid, the single photodetector 6 can measure a property of the fluid.

FIG. 8 depicts aspects of measuring radiation. Referring to FIG. 8, ionizing radiation 80 emitted from the formation 4 enters a scintillator 81. The radiation 80 generates light flashes (i.e., the photons 24). The light flashes are then measured by an array of the photodetectors 6 that are in optical communication with the scintillator 81. The array of photodetectors 6 measures an intensity of the light flashes, which is related to an amount of radiation received by the scintillator 81. The amount of radiation received by the scintillator 81, in turn, is related to an intensity of the ionizing radiation 80 emitted from the formation 4. In another embodiment, one photodetector 6 may be used to measure the light flashes.

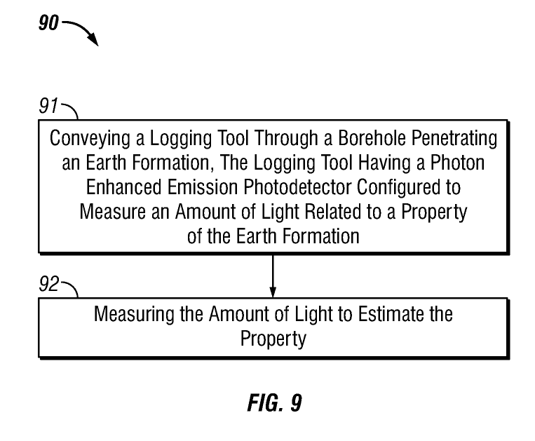

FIG. 9 presents one example of a method 90 for estimating a property of the formation 4 penetrated by the borehole 2. The method 90 calls for (step 91) conveying the logging tool 10 through the borehole 2. The logging tool 10 includes the photon enhanced emission photodetector 6 configured to measure an amount of light (i.e., the photons 24) related to the property. Further, the method 90 calls for (step 92) measuring the amount of light to estimate the property.

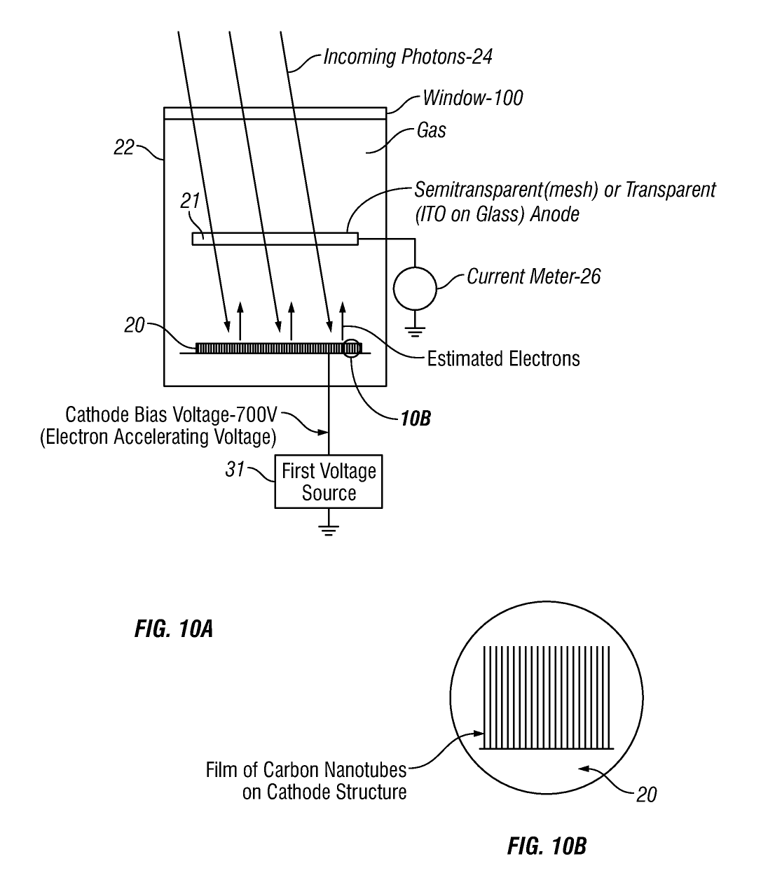

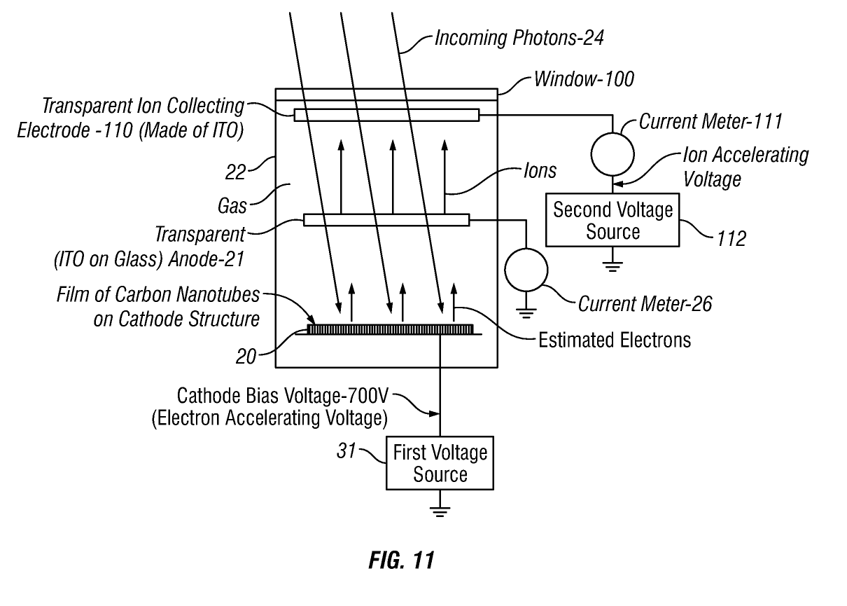

FIGS. 10 and 11 present other embodiments of the photon induced field emission device 6 configured as the photodetector 6. In these embodiments, internal signal amplification is provided based on avalanche ionization of a gas present in the enclosure 22. FIG. 10 presents an embodiment having the cathode 20 and the anode 21 (diode arrangement) while FIG. 11 presents an embodiment having an ion-collecting electrode in addition to the cathode 20 and the anode 21 (triode arrangement).

The operation principle of these embodiments of the photodetector 6 is based on initial electron induced ionization of the gas molecules (in the case of hydrogen) or atoms (in the case of inert gas) by electrons emitted from the cathode 20 by photon induced field emission interactions. The ions form a current, which is then multiplied by the process of gas ion avalanche ionization in an electric field that accelerates the ions. Both diode and triode based devices 6 can be run in linear mode (when ion current is proportional to the electron current causing the initial ionization) or Geiger mode (when an initial pulse of emitted electrons causes the discharge of the gas between the cathode 20 and the anode 21 or between the cathode 20 and the ion collecting electrode).

The mode of operation is controlled by the bias voltage creating the electric field, which accelerates the ions. The linear mode allows the measurement of the intensity of the photons received by the photodetector 6 providing some limited but linear internal gain of the signal. The Geiger mode allows detecting light pulses providing very high internal signal gain, which is strongly nonlinear.

Reference may now be had to FIG. 10A. In FIG. 10 A, the enclosure 22 contains an ionizable gas such as Xenon (Xe) or mixture of such gas with other gases of different chemical composition. Xe or other inert gases are preferred due to the highest electron induced ionization cross-section. Photons 24 enter the enclosure 22 through a window 100, pass through the anode 21, which is semitransparent (e.g., a mesh) or transparent (e.g., ITO on glass), and then interact with the cathode 20 via photon induced field emission. Emitted electrons accelerate towards the anode 21 and initially ionize the Xe atoms through the phenomenon of electron induced ionization. The electron induced ions are accelerated in the electric field, interact with neutral species and ionize the neutral species through impact ionization. With the intensity of the electric field high enough, avalanche ionization can take place. Depending on the gas concentration and the intensity of the electric field, the ion multiplication in the avalanche can be linear (i.e., the ion current is proportional to the number of electrons emitted from the cathode 20) or cause a nonlinear gas discharge between the cathode 20 and the anode 21 (Geiger operation mode). By measuring the charge deposited by the ions hitting the cathode 20 (or current flowing between cathode 20 and the anode 21), the intensity of the incoming light (in the case of linear operation mode) can be measured or the presence of the pulse of incoming light (in the case of Geiger operation mode) can be detected. In the linear mode, internal amplification of the photodetector 6 is linear. In the case of Geiger mode, even a very weak light pulse (10⁴ photons) can be detected due to very high but nonlinear signal amplification in the gas discharge.

In order to increase the efficiency of photon detection, the cathode 20 includes a film of vertically grown carbon nanotubes, nanotubes made of other materials or nanowires as shown in FIG. 10B. The efficiency of photon detection is highest using the film of carbon nanotubes (or other nano-materials) because the high “photon-to-emitted electron” transformation coefficient is provided by the highest possible surface density of electron emitters 20. The photon adsorption has to occur at the tip of each electron emitter 20 (i.e., at the tip of each carbon nanotube). As a result, the surface density of the tips defines the efficiency of the photodetector 6 assuming uniform intensity distribution of the incoming photons on the surface of the cathode 20.

Depending on the operational parameters of the photodetector 6 depicted in FIG. 10, some of the Xe or other gas atoms hitting the cathode 20 may have enough energy to destroy the carbon nanotubes at the surface of the cathode 20 so that with time the performance of the photodetector 6 will degrade due to gradual destruction of the cathode 20. In addition, there is only one parameter (cathode voltage) to control both the electron emission from the cathode 20 and the avalanche process in the gas (the cathode 20 to anode 21 is a fixed distance defining the ion accelerating electric field at fixed voltage and the gas concentration being fixed). If the photodetector 6 has to operate in a wide range of temperatures, the anode 21 to cathode 20 voltage has to be adjusted (i.e., decreased with increase in temperature) to maintain the same device sensitivity according to Fowler-Nordheim equation. However, such a voltage decrease called for with a temperature increase can cause deterioration of the ion multiplication and the overall device 6 performance instability. To overcome these potential problems, the embodiment of FIG. 10 is modified to include the ion-collecting electrode coupled to a separate voltage supply.

Reference may now be had to FIG. 11. In the embodiment of FIG. 11, an ion-collecting electrode 110 is disposed in the enclosure 22 such that the anode 21 is disposed between the ion collecting electrode 110 and the cathode 20. The ion-collecting electrode 110 is transparent to the incoming photons 24. In one exemplary embodiment, the ion-collecting electrode 110 is made of an ITO mesh. Similarly, the anode 21 is transparent to the incoming photons 24 and the emitted electrons. The incoming photons 24 enter the gas-filled enclosure 21 through the window 100 and pass through the ion collecting electrode 110 and the anode 21 before interacting with the nanotube or nanowire made field emitters at the cathode 20. The emitted electrons accelerate from the cathode 20 to the anode 21 because of the electron accelerating electric field. Any gas ions generated in a zone about the anode 21 can drift through holes in a transparent mesh made of ITO or other transparent conductor at the anode 21 and into the space between the anode 21 and the ion-collecting electrode 110. An ion accelerating electric field (powered by a second voltage source 112), separate from the electron accelerating electric field, accelerates these ions towards the ion-collecting electrode 110 and causes their avalanche multiplication. The resulting ion current is measured with current sensor 111. The measured ion current is a measure of the intensity of the incoming photons 24 in the linear mode. Gas discharge pulses measured at the ion-collecting electrode 110 in the Geiger mode are a measure of the amount of incoming light pulses.

The logging tool 10 with the photon induced emission device 6 can be configured to measure several types of measurements in the downhole environment. Non-limiting examples of the measurements include chemical composition of the formation 4 or the borehole fluid 9, emission of gamma rays from the formation 4, a boundary between layers of the formation 4, and porosity and density by detecting gamma rays from the formation 4 after irradiating the formation 4 with a neutron flux. Detection of the boundary can be by identifying changes in a measured characteristic as the logging tool 10 traverses the borehole 2.

In support of the teachings herein, various analysis components may be used, including a digital and/or an analog system. For example, the electronic unit 7, processing unit 8, or controller 29 may include the digital and/or analog system. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a sample line, sample storage, sample chamber, sample exhaust, pump, piston, power supply (e.g., at least one of a generator, a remote supply and a battery), vacuum supply, pressure supply, cooling component, heating component, motive force (such as a translational force, propulsional force or a rotational force), magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

The term “carrier” as used herein means any device, device component, combination of devices, media and/or member that may be used to convey, house, support or otherwise facilitate the use of another device, device component, combination of devices, media and/or member. The logging tool 10 is one non-limiting example of a carrier. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The term “couple” relates to coupling a first device to a second device either directly or indirectly via one or more intermediate devices.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. For example, the measurement apparatus 5 and the photodetector 6 may be included in one unit. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed:

1. An apparatus for estimating a property of a subterranean material, the apparatus comprising:
a photon induced emission device configured to be disposed in a borehole penetrating the subterranean material and to provide an output related to an induced emission interaction with a received photon that generates an electron that is used for providing the output;
wherein the output is used for estimating the property.

2. The apparatus of claim 1, further comprising a carrier wherein the photon induced emission device is disposed at the carrier.

3. The apparatus of claim 2, wherein the carrier is configured to be conveyed by at least one of a drill string, a wireline, a slickline, and coiled tubing.

4. The apparatus of claim 1, wherein the output is an electrical signal related to an amount of received photons interacting with the device.

5. The apparatus of claim 4, wherein the photon induced emission device comprises:
a cathode comprising a conducting surface configured to emit the electron upon the electron colliding with the received photon by subjecting the surface to a condition allowing for at least one selection from a group consisting of photon induced thermionic emission and photon induced field emission;
an anode configured to receive the emitted electron; and
a first voltage source coupled to the cathode and the anode and configured to provide an electric field between the cathode and the anode to accelerate the emitted electron from the cathode to the anode.

6. The apparatus of claim 5, wherein the photon induced emission device comprises a plurality of cathodes.

7. The apparatus of claim 6, wherein the plurality of cathodes comprises at least one of a plurality of nanotubes and a plurality of nanowires.

8. The apparatus of claim 7, wherein the nanotubes comprise carbon.

9. The apparatus of claim 5, wherein an amount of electrons received by the anode relates to the amount of received photons interacting with the photon induced emission device.

10. The apparatus of claim 5, wherein the cathode and the anode are disposed in an enclosure configured to seal one of a vacuum and a gas.

11. The apparatus of claim 10, wherein the gas is an inert gas configured to be ionized by the electron accelerating in the electric field to create avalanche breakdown of the gas to provide the electrical signal.

12. The apparatus of claim 11, wherein the electrical signal is proportional to the amount of received photons.

13. The apparatus of claim 11, wherein the electrical signal is a pulse related to a pulse of received photons.

14. The apparatus of claim 11, wherein the photon induced emission device further comprises:
an ion collecting electrode disposed in the enclosure and configured to collect ions generated by the avalanche breakdown of the gas; and
a second voltage source coupled to the anode and to the ion collecting electrode and configured to provide an electric field between the anode and the ion collecting electrode to accelerate ions to the ion collecting electrode;
wherein the anode is configured to be fully or partially transparent to the ions and an amount of collected ions is used to provide the electrical signal.

15. The apparatus of claim 14, wherein the cathode comprises at least one of a plurality of nanotubes and a plurality of nanowires.

16. The apparatus of claim 1, wherein the photon induced emission device is implemented as a micro-electromechanical system (MEMS).

17. The apparatus of claim 1, wherein the photon induced emission device is operable up to at least 300° C.

18. The apparatus of claim 1, wherein the property is at least one of a chemical composition, a boundary between layers of the formation, an amount of radiation emitted from the formation, porosity, and density.

19. A method for estimating a property of a subterranean material penetrated by a borehole, the method comprising:
disposing a photon induced emission device in the borehole, the photon induced emission device being configured to provide an output related to an induced emission interaction with a received photon that generates an electron that is used for providing the output wherein the output is used for estimating the property;
receiving a photon to produce the induced emission interaction that generates the electron; and
using the electron to provide the output to estimate the property.

20. The method of claim 19, wherein the output comprises an electrical signal related to an amount of received photons interacting with the device, the received photons being related to the property.

21. The method of claim 20, further comprising subtracting dark current from the electrical signal to compensate for an electron emitted without an induced emission interaction with a photon.

22. A computer readable medium comprising computer executable instructions for estimating a property of a subterranean material penetrated by a borehole by implementing a method comprising:
generating output from a photon induced emission device configured to be disposed in the borehole and to provide an output related to an induced emission interaction with a received photon that generates an electron that is used for providing the output wherein the output is used for estimating the property; and
using the output to estimate the property.
